(19) United States
(12) Patent Application Publication
(10) Pub. No.: US 2011/0058135 A1
(43) Pub. Date: Mar. 10, 2011

(54) DISPLAY DEVICE

(75) Inventor: Katsunori Misaki, Osaka-shi (JP)

(73) Assignee: SHARP KABUSHIKI KAISHA, Osaka-shi, Osaka (JP)

(21) Appl. No.: 12/937,381

(22) PCT Filed: Feb. 20, 2009
(86) PCT No.: PCT/JP2009/000744

§ 371 Date: Oct. 12, 2010

(30) Foreign Application Priority Data
May 26, 2008 (JP) 2008-136305

(51) Int. Cl. G02F 1/1339

(52) U.S. Cl. 349/153

(57) ABSTRACT

In a liquid crystal display device 10, a plurality of structures 25 are formed in a part of a first substrate 12 located in a seal region 17′ to be arranged in a direction in which the seal region 17′ extends, and at least one eave portion 26 is formed on the structures 25 to protrude in a direction along a surface of an insulating base material and provide voids 27 under the at least one eave portion 26. A sealant 17 is provided on the at least one eave portion 26 to adhere to the at least one eave portion 26 and is filled in the voids 27 to adhere to the structures 25.

### TECHNICAL FIELD

The present invention relates to display devices, and more particularly, relates to a display device in which a pair of substrates are bonded together at an outer circumference portion with a sealant.

### BACKGROUND ART

Liquid crystal display devices, which are a type of display device, are thin and light weight, and have been widely used for mobile devices such cellular phones, AV devices such as liquid crystal TV sets, and the like. Liquid crystal display panels used as a component of such liquid crystal display devices include a first substrate and a second substrate arranged to face each other and a liquid crystal layer provided between the substrates.

In such a liquid crystal display panel, the first substrate and the second substrate are bonded together with seal portions each being formed in a non-display region provided at an outer circumference portion of each of the substrates.

In general, the seal portions are made of a sealing material such as epoxy resin, and therefore, tend to have low adhesion strength, for example, with an organic insulating film formed on a surface of each substrate.

Recently, as the thickness of liquid crystal display panels has become smaller and smaller, the thickness of each substrate as a component of such a liquid crystal display panel is reduced accordingly, and thus, the substrate is easily deformed. In particular, when a liquid crystal display panel is produced and mounted components such as external connection terminals are mounted on the liquid crystal display panel, the substrates are deformed under load, and thus, the pair of substrates bonded together with seal portions might be separated from each other.

Also, in recent years, there are an increasing number of cases where, in a liquid crystal display panel fabrication process, the liquid crystal dropping/bonding method having a higher productivity than that of the known dip injection method is used as a method for supplying a liquid crystal material between a pair of substrates to form a liquid crystal layer. In the liquid crystal dropping/bonding method, for example, a seal portion having a rectangular frame shape is formed in one of a pair of substrates, and then, a liquid crystal material is dropped into the inside of the seal portion of the substrate, thereby bonding the one of the substrates to the other one of the substrate. It is likely that the adhesion strength of a liquid crystal display panel formed using the liquid crystal dropping/bonding method is lower than that of a liquid crystal display panel formed using the dip injection method because of differences in material used for the seal portion. Therefore, there are still cases where the substrates are separated from each other.

Furthermore, specifically, in a mobile device such as a cellular phone, the frame narrowing technique in which a non-display region in an outer circumference portion which does not contribute to display of a liquid crystal display panel is narrowed is developed, and therefore, the width of the seal portion provided in the non-display region is expected to be reduced. To reduce the width of the seal portion, a pair of substrates have to be bonded to together in a limited area, and thus, it is highly possible that the substrates are separated from one another.

As described above, in such a liquid crystal display panel, it is likely that substrates are easily separated from each other due to reduction in thickness of the liquid crystal display panel, a fabrication process, frame narrowing, and the like. Therefore, improvement of the adhesive strength of the seal portion between a pair of substrates is required.

To solve the above-described problems, for example, PATENT DOCUMENT 1 discloses a liquid crystal display device 100 having a configuration shown in FIGS. 11 and 12. FIG. 11 is a plan view of the known liquid crystal display device 100 of PATENT DOCUMENT 1, and the like. FIG. 12 is an enlarged plan view of a seal region 117′ within a dotted frame S of FIG. 11.

As shown in FIG. 11, the liquid crystal display device 100 includes a thin film transistor substrate 112 having terminal portions 115, and a liquid crystal display panel 111 comprised of a color filter substrate 113. The thin film transistor substrate 112 and the color filter substrate 113 are bonded to together with a sealant 117 so that a liquid crystal layer is interposed between the thin film transistor substrate 112 and the color filter substrate 113. The sealant 117 is provided in the seal region 117′ located around a display region 116.

As shown in FIG. 12, in the seal region 117′, a gate layers 120 is formed into strips and the plurality of strips of the gate layers 120 are arranged with a predetermined space between one another so that each of the strips of the gate layer 120 extends along the width direction of the seal region 117′. Step portions are formed by the strips of the gate layer 120 to increase an adhesion area with the sealant 117, thereby improving the adhesion strength.

### CITATION LIST

### Patent Document

PATENT DOCUMENT 1: Japanese Patent Publication No. 09-33933

### SUMMARY OF THE INVENTION

### Technical Problem

In the liquid crystal display device 100, when the thin film transistor substrate 112 and the color filter substrate 113 are bonded at a predetermined position, desired adhesion strength can be achieved between the two substrates. However, if the substrates are misaligned to be shifted from each other when being bonded, the sealant 117 is not arranged at a predetermined position, and a problem in which a space between the thin film transistor substrate 112 and the color filter substrate 113, i.e., a cell thickness varies arises.

Also, since the strips of the gate layer 120 are arranged with a predetermined space between one another so that each of the strips of the gate layer 120 extends along the width direction of the seal region 117′, moisture and a foreign matter might externally enter between the strips of the gate layer 120 to be mixed in the display region 116, thereby causing a display defect.

In view of the above-described points, the present invention has been devised and it is therefore an object of the present invention to provide a display device having good adhesive strength between bonded substrates, a reliably controlled cell thickness, and good display quality.

### Solution to the Problem

A display device according to the present invention includes: first and second substrates arranged to face each other, each including an insulating base material; a display medium layer provided between the first and second substrates; and a sealant provided in a seal region surrounding the display medium layer for bonding the first and second substrates, in a part of the first substrate located in the seal region, a plurality of structures are formed on the insulating base material to be arranged in a direction in which the seal region extends, at least one eave portion is formed on the plurality of structures to protrude in a direction along a surface of the insulating base material and provide voids under the at least one eave portion, and the sealant is provided over the at least one eave portion to adhere to the at least one eave portion and is filled in the voids to adhere to the structures.

The display device of the present invention may be configured so that each of the structures is formed into a raised shape.

The display device of the present invention may be configured so that the structures are formed on the insulating base material and are made of the same insulating layer as an insulating layer provided in a display region.

The display device of the present invention may be configured so that each of the voids is a side portion of an associated one of notches formed in the insulating layer.

The display device of the present invention may be configured so that the at least one eave portion is made of the same semiconductor film as a semiconductor film provided on a part of the insulating layer located in a display region.

The display device of the present invention may be configured so that upper structures each having a raised shape are formed on the at least one eave portion, and upper eave portions are formed on the upper structures to protrude in a direction along the surface of the insulating base material and provide voids under the upper eave portions.

The display device of the present invention may be configured so that the upper structures are made of the same semiconductor film as a semiconductor film provided in a display region.

The display device of the present invention may be configured so that the upper eave portions are made of the same metal thin film as a metal thin film provided in a display region.

The display device of the present invention may be configured so that the structures are formed to be arranged along an entire circumference of the seal region surrounding the display medium layer.

### ADVANTAGES OF THE INVENTION

According to the present invention, a display device having good adhesive strength between bonded substrates, a reliably controlled cell thickness, and good display quality can be provided.

### BRIEF DESCRIPTION OF THE DRAWINGS

FIG. 1 is a plan view of a liquid crystal display device according to a first embodiment of the present invention.

FIG. 2 is a cross-sectional view of the liquid crystal display device of the first embodiment of the present invention.

FIG. 3 is a cross-sectional view of a thin film transistor substrate.

FIG. 4 is a cross-sectional view of a color filter substrate.

FIG. 5 is an enlarged plan view of a seal region and its periphery within a doted frame S of FIG. 1.

FIG. 6 is a cross-sectional view of the thin film transistor substrate taken along the line A-A′ of FIG. 5.

FIG. 7 is an enlarged plan view of a seal region and its periphery in a liquid crystal display device according to a second embodiment of the present invention.

FIG. 8 is a cross-sectional view of a thin film transistor substrate taken along the line A-A′ of FIG. 7.

FIG. 9 is an enlarged plan view of a seal region and its periphery in a liquid crystal display device according to a third embodiment of the present invention.

FIG. 10 is a cross-sectional view of a thin film transistor substrate taken along the line A-A′ of FIG. 9.

FIG. 11 is a plan view of a known liquid crystal display device.

FIG. 12 is an enlarged plan view of a seal region within a dotted frame S of FIG. 11.

### DESCRIPTION OF REFERENCE CHARACTERS

10, 30, 50 Liquid Crystal Display Device
11 Liquid Crystal Display Panel
12, 32, 52 Thin Film Transistor Substrate
13 Color Filter Substrate
16, 36, 56 Display Region
20, 40, 60 Glass Substrate
21, 41, 61 Liquid Crystal Layer
22, 42, 62 Gate Insulating Film
23, 43, 63 Interlevel Insulating Film
24, 44, 64 Protective Film
25, 45, 65 Structure
29, 48, 68 Semiconductor Film
26, 46, 66 Eave Portion
27, 47, 67, 92 Void
17, 37, 57 Sealant
17′, 37′, 57′ Seal Region
49, 69, 73 n⁺ semiconductor film
72 Gate Electrode
75 Source Electrode
76 Drain Electrode
77 Thin Film Transistor
90 Upper Structure
91 Upper Eave Portion

### DESCRIPTION OF EMBODIMENTS

According to embodiments of the present invention, structures of a display device, and methods for fabricating a display device will be described in detail hereinafter with reference to the accompanying drawings. A liquid crystal display device will be described as an example of a display device according to the present invention. Note that the present invention is not limited to the following embodiments.

### First Embodiment

### Structure of Liquid Crystal Display Device 10

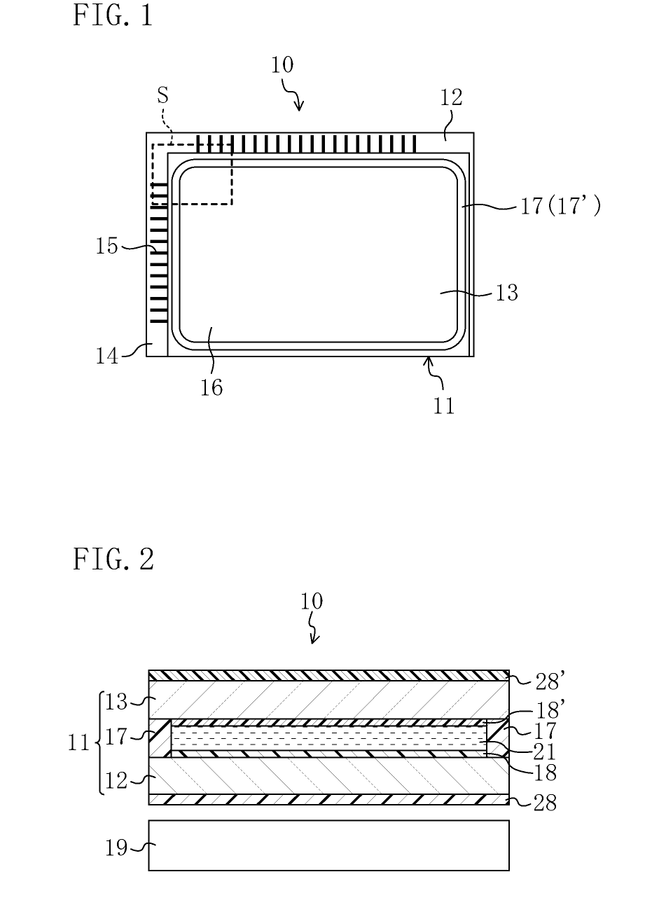

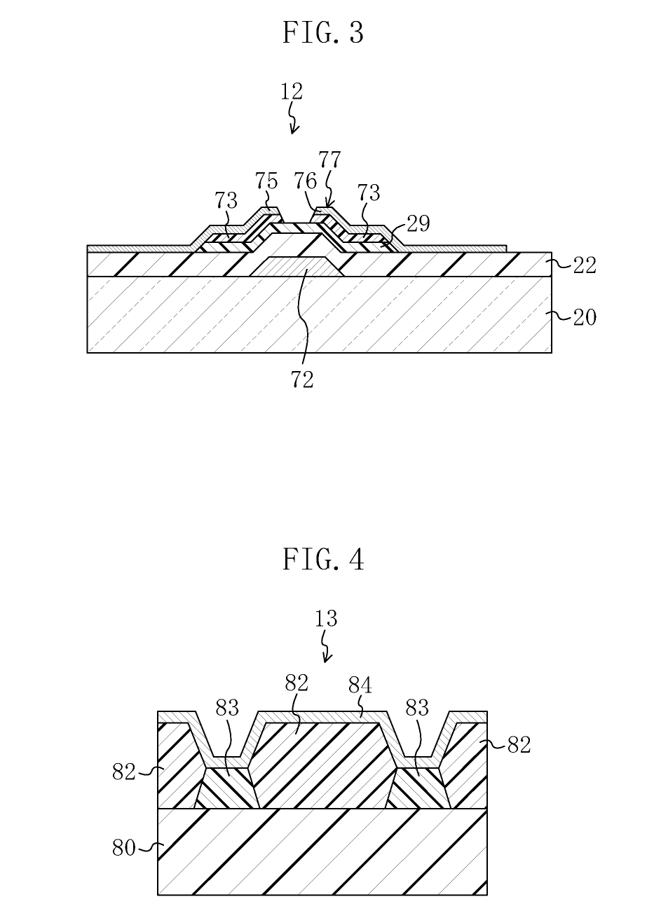

FIG. 1 is a plan view of a liquid crystal display device 10 according to a first embodiment of the present invention. FIG. 2 is a cross-sectional view of the liquid crystal display device 10. FIG. 3 is a cross-sectional view of a thin film transistor substrate 12. FIG. 4 is a cross-sectional view of a color filter substrate 13. The liquid crystal display device 10 is comprised of a liquid crystal display panel 11 and a back light 19.

The liquid crystal display panel 11 is comprised of the thin film transistor substrate 12 (first substrate) and the color filter substrate 13 (second substrate) each of which is a thin film layered device in which a plurality of thin films are stacked on an insulating base material such as a glass substrate and the like. The liquid crystal display panel 11 includes a liquid crystal layer 21 formed between the thin film transistor substrate 12 and the color filter substrate 13.

FIG. 3 is a cross-sectional view of the thin film transistor substrate 12. In the thin film transistor substrate 12, a plurality of pixels (not shown) are provided, and a thin film transistor 77 is formed in each pixel. An orientation film 18 is provided on a surface of the thin film transistor substrate 12 located closer to the liquid crystal layer 21, and a polarizing plane 28 is provided on a surface of the thin film transistor substrate 12 located at the opposite side.

The thin film transistor substrate 12 is comprised of, for example, a glass substrate 20 having a thickness of 0.7 mm On one of surfaces of the glass substrate 20, a SiNx film (not shown) is formed as a base coating layer to have a thickness of, for example, 150 nm In a part of the SiNx film corresponding each pixel, a gate electrode 72 made of, for example, Ti, is formed to have a thickness of about 200 nm, and a gate insulating film 22, for example, comprised of a SiNx layer is formed to cover the SiNx film and the gate electrode 72 and to have a thickness of about 400 nm.

A semiconductor film 29 is formed on the gate insulating film 22 to entirely cover the gate electrode 72 with the gate insulating film 22 interposed between the gate electrode 72 and the semiconductor film 29 and to have a thickness of, for example, about 150 nm. For example, the semiconductor film 29 is made of at least one of amorphous Si (a-Si), polycrystalline Si, microcrystalline Si, oxide semiconductor, and the like.

On the semiconductor film 29, an n⁺ semiconductor film 73, which is doped with a high concentration of an n-type impurity, is formed to have a thickness of, for example, about 50 nm. A source electrode 75 and a drain electrode 76 each being made of, for example, Ti, are formed above the n⁺ semiconductor film 73 and the gate insulating film 22 so that each of the source electrode 75 and the drain electrode 76 has a thickness of about 200 nm. As described above, the thin film transistor 77 having the gate electrode 72, the n⁺ semiconductor film 75, and the drain electrode 76 is formed in the thin film transistor substrate 12. The thin film transistor 77 is covered by an interlevel insulating film 23 and a protective film 24 each of which is comprised of, for example, a SiNx layer. Although not shown in FIG. 3, a pixel electrode which is a component of each pixel is formed on the drain electrode 76 with the interlevel insulating film 23 and the protective film 24 interposed between the drain electrode 76 and the pixel electrode, and the drain electrode 76 is electrically coupled to the pixel electrode through a contact hole formed in the interlevel insulating film 23 and the protective film 24.

The thin film transistor substrate 12 is formed to have a larger area than that of the color filter substrate 13, and thus, as shown in FIG. 1, a region (margin region 14) in which a part of the thin film transistor substrate 12 is left as a margin is created when the thin film transistor substrate 12 and the color filter substrate 13 are bonded together. Terminal portions 15 for transmitting an external signal and the like are formed in the margin region 14.

The color filter substrate 13 is comprised of a glass substrate 80 (insulating base material) and, for example, a SiNx film (not shown) is formed as a base coating layer on the glass substrate 80 to have a thickness of 150 nm. A plurality of color filter layers 82, each of which is a component of each pixel, are formed on the SiNx film with a predetermined space therebetween. A black matrix layer 83 is formed between adjacent ones of the color filter layers 82 to define a boundary between the adjacent ones of the color filter layers 82, and a counter electrode 84 is formed to cover the color filter layers 82 and the black matrix layers 83. An orientation film 18′ is provided on a surface of the color filter substrate 13 located closer to the liquid crystal layer 21, and a polarizing plane 28′ is provided on a surface of the color filter substrate 13 located at the opposite side to the liquid crystal layer 21.

The liquid crystal layer 21 is surrounded by a sealant 17 provided between the thin film transistor substrate 12 and the color filter substrate 13, and is sealed by the sealant 17. To provide a uniform space between the thin film transistor substrate 12 and the color filter substrate 13, a column-shaped spacer (not shown) made of, for example, plastic, glass, and the like is provided between the thin film transistor substrate 12 and the color filter substrate 13.

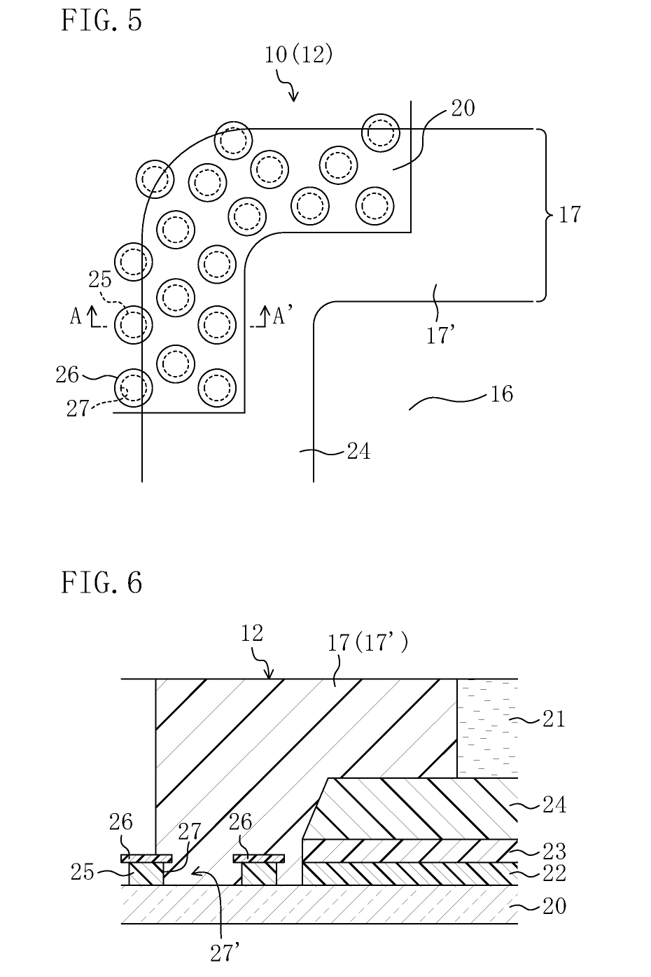

Next, a seal region 17′ and its periphery in the liquid crystal display device 10 will be described. FIG. 5 is an enlarged plan view of the seal region 17′ and its periphery within a dotted frame S of FIG. 1. FIG. 6 is a cross-sectional view of the thin film transistor substrate 12 taken along the line A-A′ of FIG. 5.

The gate insulating film 22, the interlevel insulating film 23, and the protective film 24 which are stacked in a display region 16 are located also in a part of the thin film transistor substrate 12 located in the seal region 17′. The stacked films are notched in the seal region 17′, and the glass substrate 20 is exposed in the seal region 17′. Structures 25 made of the same material as that of the gate insulating film 22 are provided on the glass substrate 20.

The plurality of the structures 25 are formed on the part of the glass substrate 20 located in the seal region 17′ to be arranged in the direction in which the seal region 17′ extends along the entire circumference of the seal region 17′. Each of the structures 25 is formed into a raised shape. More specifically, each of the structures 25 is formed to have a circular column shape, for example, having a height of about 400 nm and a diameter of about 400 nm. However, the shape of each of the structures 25 is not particularly limited and, as long as the structure 25 is formed into a raised shape, each of the structures 25 may be formed to have a rectangular column shape, a tapered shape, an inverse tapered shape, and the like.

Eave portions 26 are provided on the plurality of structures 25. Each of the eave portions 26 is formed to have a circular column shape having, for example, a height of about 100 nm and a diameter of about 500 nm. Each of the eave portions 26 protrudes in a direction along a surface of the glass substrate 20 to provide a void 27 under the eave portion 26. Each of the voids 27 is a side portion of an associated one of notches 27′ formed in the gate insulating film 22. The shape of the eave portions 26 is not particularly limited and, as long as the voids 27 can be provided by the eave portions 26, each of the eave portions 26 may be formed to have a rectangular column shape, a tapered shape, and the like. The eave portions 26 are made of the same material as that of the semiconductor film 29 provided in the display region 16.

The sealant 17, which is provided between the thin film transistor substrate 12 and the color filter substrate 13 and in the seal region 17′ to surround the liquid crystal layer 21, is located over the eave portions 26 to adhere to the eave portions 26, and also is filled in the voids 27 formed in the gate insulating film 22 to adhere to the structures 25.

(Method for Fabricating Liquid Crystal Display Device 10)

Next, a method for fabricating the liquid crystal display device 10 according to an embodiment of the present invention will be described. Note that the following fabrication method is merely an example, and the liquid crystal display device 10 according to the present invention is not limited to a liquid crystal display device fabricated by the following method.

First, a glass substrate 20 to serve as a base of the thin film transistor substrate 12 is prepared. Then, a base coating layer is formed on the glass substrate 20. Subsequently, a Ti film is formed on the base coating layer by sputtering to have a thickness of about 200 nm, and then, patterning is performed using photolithography to form gate electrodes 72. Next, a SiN film (400 nm), an a-Si (150 nm), and n⁺Si (50 nm) are continuously formed as a gate insulating film 22, a semiconductor film 29, and an n⁺ semiconductor film 73 at high temperature of 250° C. by CVD. Subsequently, a-Si and n⁺Si are patterned into islands using photolithography. At the same time, the semiconductor film 29 in the seal region 17′ is patterned using the same patterning mask so that a plurality of circular regions are formed to be arranged in the direction in which the seal region 17′ extends along the entire circumference of the seal region 17′.

Next, a Ti film is formed by sputtering over parts of the gate insulating film 22, the semiconductor film 29, and the n⁺ semiconductor film 73 located in a display region 16 to have a thickness of about 200 nm, and then, patterning is performed using photolithography to form source electrodes 75 and drain electrodes 76.

Subsequently, an interlevel insulating film 23 and a protective film 24 are formed using the SiNx layer and the like, and etching is performed to form contact holes in the interlevel insulating film 23 and the protective film 24 so that each of the contact holes extends from a surface of the protective film 24 to the drain electrode 76. At the same time, etching is performed to remaining parts of the semiconductor film 29 and the gate insulating film 22 in the seal region 17′ using the same mask. In this case, an etching speed of etching of the gate insulating film 22 (SiN) is higher than an etching speed of etching of the semiconductor film 29 (a-Si), and thus, other (exposed) parts of the gate insulating film 22 than parts thereof located under the plurality of circular regions made of the semiconductor film 29 are etched faster than the semiconductor film 29. By further performing etching, a large part of the gate insulating film 22 is etched, and the gate insulating film 22 becomes narrow. Thus, structures 25 are formed, and eave portions 26 are made of the semiconductor film 29 on the structures 25 so that each of the eave portions 26 protrudes in a direction along a surface of the glass substrate 20 to provide a void 27 under the eave portion 26.

Next, pixel electrodes are formed on the protective film 24 so that each of the pixel electrodes is electrically coupled to an associated one of the drain electrodes 76 through an associated one of the contact holes, and subsequently, an orientation film 18 is formed, thus forming a thin film transistor substrate 12.

Next, a glass substrate 80 to serve as a base of the color filter substrate 13 is prepared. Then, thin films, i.e., a color filter layer 82, a counter electrode 84, and the like, and an orientation film 18′ are formed, thus forming a color filter substrate 13.

Subsequently, a sealant 17 is applied to one of the thin film transistor substrate 12 and the color filter substrate 13 at a part thereof located closer to the orientation film 18 or 18′ and in a seal region 17′ so as to have a substantially frame shape. Thus, the sealant 17 is provided on the eave portions 26 to adhere to the eave portions 26, and is filled in the voids 27 formed in the gate insulating film 22 to adhere to the structures 25. Note that the sealant 17 is formed so that an inlet for injecting a liquid crystal material is formed when the thin film transistor substrate 12 and the color filter substrate 13 are bonded together.

Next, the thin film transistor substrate 12 and the color filter substrate 13 are bonded together with the sealant 17 interposed therebetween so that a surface of the thin film transistor substrate 12 on which the orientation film 18 is provided faces a surface of the color filter substrate 13 on which the orientation film 18′ is provided. Then, after the liquid crystal material is injected through the inlet, the inlet is sealed, thus forming a liquid crystal layer 21.

Next, polarizing planes 28 and 28′ are respectively bonded to surfaces of the thin film transistor substrate 12 and the color filter substrate 13 each of which is located at an opposite side to the liquid crystal layer 21 to form a liquid crystal display panel 11. Then, a back light 19 is provided to the liquid crystal display panel 11 to complete a liquid crystal display device 10.

### Second Embodiment

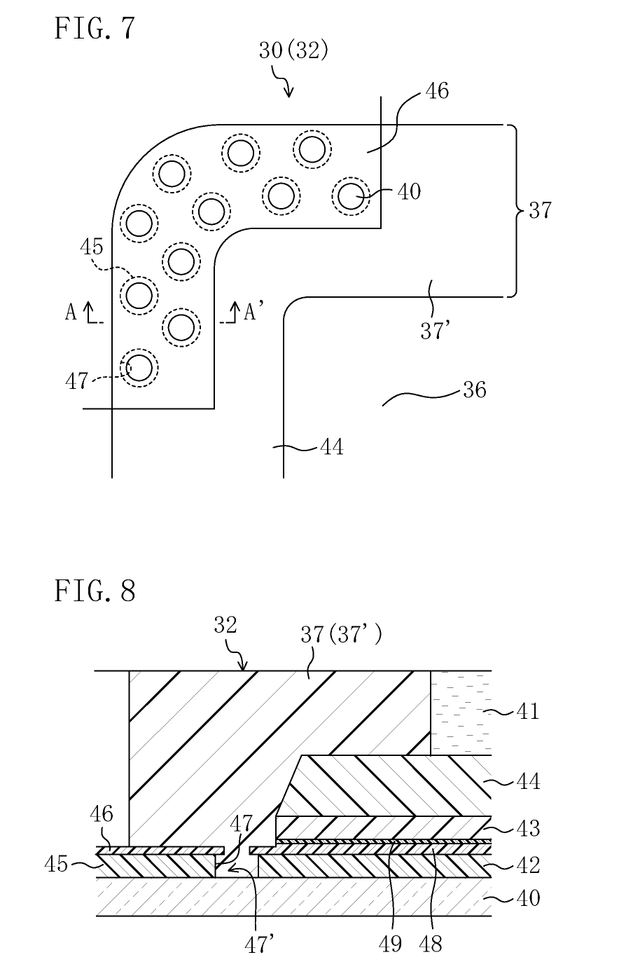

Next, a second embodiment of the present invention will be described. FIG. 7 is an enlarged plan view of a seal region 37′ and its periphery in a liquid crystal display device 30 according to the second embodiment of the present invention. FIG. 8 is a cross-sectional view of a thin film transistor substrate 32 taken along the line A-A′ of FIG. 7.

A gate insulating film 42, a semiconductor film 48 (a-Si), an n⁺ semiconductor film 49 (n⁺Si), an interlevel insulating film 43, and a protective film 44 which are stacked in a display region are also located in the seal region 37′ of the thin film transistor substrate 32. The stacked layers are notched in the seal region 37′ so that notches 47′ are formed, and a glass substrate 40 is exposed at the notches 47′. Each of the notches 47′ is formed to have a circular column shape, for example, having a height of about 400 nm and a diameter of about 400 nm. However, the shape of the notches 47′ is not limited to the above example, but may be a rectangular column shape, a tapered shape, an inverse tapered shape, and the like.

Structures 45 made of the same material as that of the gate insulating film 42 are provided on a part of the glass substrate 40 located in the seal region 37′ so as to be located adjacent to the notches 47′, and are arranged in the direction in which the seal region 37′ extends along the entire circumference of the seal region 37′.

An eave portion 46 is formed over the structures 45. The eave portion 46 protrudes in a direction along a surface of the glass substrate 40 to provide voids 47 under the eave portion 46. Each of the voids 47 is a side portion of an associated one of the notches 47′. The eave portion 46 is made of the same material as that of the semiconductor film 48 provided in the display region 36.

A sealant 37, which is provided between the thin film transistor substrate 32 and a color filter substrate and in the seal region 37′ to surround a liquid crystal layer 41, is located over the eave portion 46 to adhere to the eave portion 46, and is filled in the voids 47 formed in the gate insulating film 42 to adhere to the structure 45.

Similar to the first embodiment, the structures 45 and the eave portion 46 provided in the seal region 37′ can be formed simultaneously with forming corresponding components of the thin film transistor substrate 32. Specifically, first, a glass substrate 40 to serve as a base of the thin film transistor substrate 32 is prepared. Then, a base coating layer and gate electrodes are formed on the glass substrate 40. Next, a SiN film, a-Si, and n⁺Si are continuously formed as a gate insulating film 42, a semiconductor film 48, and an n⁺ semiconductor film 49, and subsequently, a-Si and n⁺Si are patterned into islands using photolithography. At the same time, a part of the semiconductor film 48 located in the seal region 37′ is also pattered using the same mask so that a plurality of circular holes are formed to be arranged in the direction in which the seal region 37′ extends along the entire circumference of the seal region 37′.

Next, a Ti film is formed by sputtering over parts of the gate insulating film 42, the semiconductor film 48, and the n⁺ semiconductor film 49 located in the display region 36 to have a thickness of about 200 nm, and then, patterning is performed using photolithography to form source electrodes and drain electrodes.

Subsequently, an interlevel insulating film 43 and a protective film 44 are formed using a SiNx layer and the like, and then, etching is performed to form contact holes in the interlevel insulating film 43 and the protective film 44 so that each of the contact holes extends from a surface of the protective film 44 to an associated one of the drain electrodes. At the same time, etching is performed to remaining parts of the semiconductor film 48 and the gate insulating film 42 in the seal region 37′ using the same mask. In this case, an etching speed of etching of the gate insulating film 42 (SiN) is higher than an etching speed of etching of the semiconductor film 48 (a-Si), and thus, parts of the gate insulating film 42 corresponding to the plurality of circular holes formed in the semiconductor film 48 are etched faster. By further performing etching, a large part of the gate insulating film 42 is etched, and the gate insulating film 42 becomes narrow. Thus, structures 45 are formed, and an eave portion 46 is made of the semiconductor film 48 over the structures 45 so that the eave portion 46 protrudes in the direction along the surface of the glass substrate 40 to provide voids 47 under the eave portion 46. During this step, a plurality of notches 47′ are formed so that each of the notches 47′ has a circular column shape whose side portion is an associated one of the voids 47.

Next, pixel electrodes are formed on the protective film 44 so that each of the pixel electrodes is electrically coupled to an associated one of the drain electrodes through an associated one of the contact holes, and subsequently, an orientation film is formed, thus forming a thin film transistor substrate 32.

Next, similar to the first embodiment, a color filter substrate is formed, and subsequently, a sealant 37 is applied to one the thin film transistor substrate 32 and the color filter substrate at a part thereof located closer to an associated one of the orientation films and in a seal region 37′ so as to have a substantially frame shape. Thus, the sealant 37 is located over the eave portion 46 to adhere to the eave portion 46, and is filled in the voids 47 formed in the gate insulating film 42 to adhere to the structures 45.

Next, a polarizing plane is bonded to each of surfaces of the thin film transistor substrate 32 and the color filter substrate each of which is located at an opposite side to a liquid crystal layer 41 to form a liquid crystal display panel. Then, a back light is provided to the liquid crystal display panel to complete a liquid crystal display device 30.

### Third Embodiment

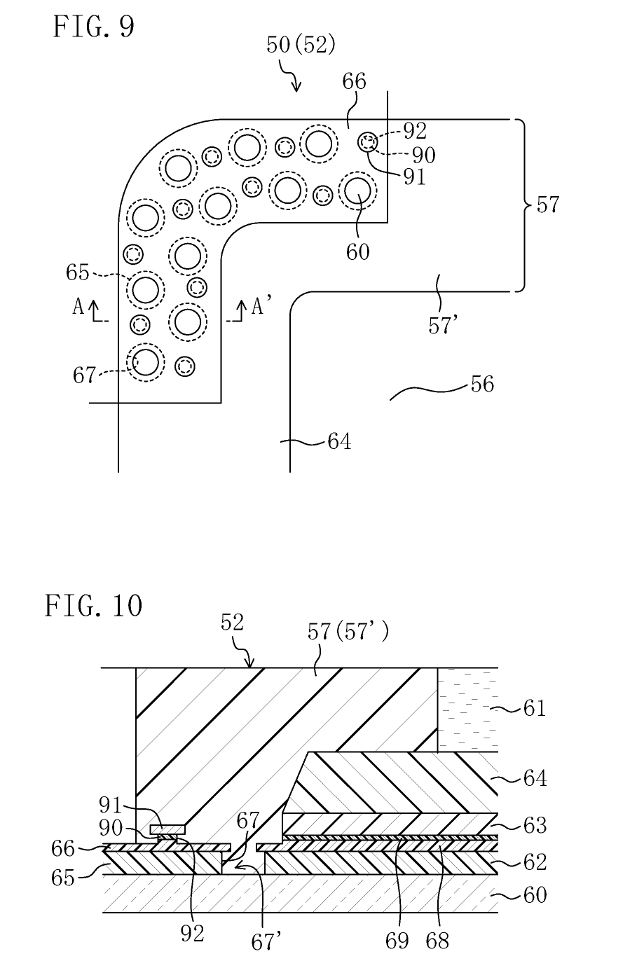

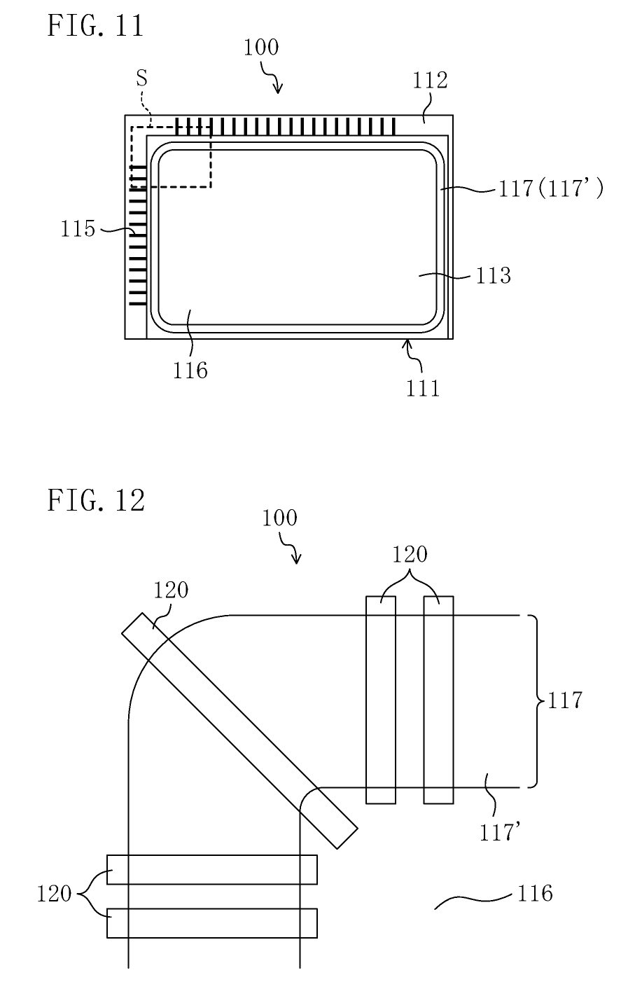

Next, a third embodiment of the present invention will be described. FIG. 9 is an enlarged plan view of a seal region 57′ and its periphery in a liquid crystal display device 50 according to a third embodiment of the present invention. FIG. 10 is a cross-sectional view of a thin film transistor substrate 52 taken along the line A-A′ of FIG. 9.

A gate insulating film 62, a semiconductor film 68 (a-Si), an n⁺ semiconductor film 69 (n⁺Si), an interlevel insulating film 63, and a protective film 64 which are stacked in a display region 56 are also located in the seal region 57′ of the thin film transistor substrate 52. The stacked layers are notched in the seal region 57′ so that notches 67′ are formed, and a glass substrate 60 is exposed at the notches 67′. Each of the notches 67′ is formed to have a circular column shape, for example, having a height of about 400 nm and a diameter of about 400 nm. However, the shape of the notches 67′ is not limited to the above example, but may be a rectangular column shape, a tapered shape, an inverse tapered shape, and the like.

Structures 65 made of the same material as that of the gate insulating film 62 are provided on a part of the glass substrate 60 located in the seal region 57′ so as to be located adjacent to the notches 67′, and are arranged in the direction in which the seal region 57′ extends along the entire circumference of the seal region 57′.

An eave portion 66 is formed over the structures 65. The eave portion 66 protrudes in a direction along a surface of the glass substrate 60 to provide voids 67 under the eave portion 66. Each of the voids 67 is a side portion of an associated one of the notches 67′. The eave portion 66 is made of the same material as that of the semiconductor film 68 provided in the display region 56.

Upper structures 90 each having a raised shape are formed on the eave portion 66, and upper eave portions 91 are formed on the upper structures 90 so as to protrude in the direction along the glass substrate 60 and provide voids 92.

The upper structures 90 are made of the same material as that of the n⁺ semiconductor film 69 (n⁺Si) provided in the display region 56. Each of the upper structures 90 is formed to have a circular column shape having, for example, a height of about 100 nm and a diameter of about 100 nm.

The upper eave portions 91 are made of the same metal thin film as the metal thin film of which source electrodes and drain electrodes are formed. Each of the upper eave portions 91 is formed to have a circular column shape having, for example, a height of about 200 nm and a diameter of about 200 nm.

A sealant 57, which is provided between the thin film transistor substrate 52 and the color filter substrate and in the seal region 57′ to surround a liquid crystal layer 61, is located over the eave portion 66 and the upper eave portions 91 to adhere to the eave portion 66 and the upper eave portions 91, and is filled in the voids 67 and 92 formed in the gate insulating film 62 and the n⁺ semiconductor film 69 to adhere to the structures 65 and the upper structures 90.

Similar to the first embodiment, the structures 65, the eave portion 66, the upper structures 90, and the upper eave portions 91 in the seal region 57 can be formed simultaneously with forming corresponding components of the thin film transistor substrate 52. Specifically, first, a glass substrate 60 to serve as a base of a thin film transistor substrate 52 is prepared. Then, a base coating layer and gate electrodes are formed on the glass substrate 60. Next, a SiN film, a-S, and n⁺Si are continuously formed as a gate insulating film 62, a semiconductor film 68, and an n⁺ semiconductor film 69, and subsequently, a-Si and n⁺Si are patterned into islands using photolithography. At the same time, a part of the semiconductor film 68 located in the seal region 57′ is also pattered using the same mask so that a plurality of circular holes are formed to be arranged in the direction in which the seal region 57′ extends along the entire circumference of the seal region 57′. Furthermore, patterning is performed to the n⁺ semiconductor film 69 to form a plurality of upper structures 90 each having a circular column shape in other parts of the n⁺ semiconductor film 69 than parts thereof corresponding to the circular holes in the semiconductor film 68.

Next, a Ti film is formed by sputtering over parts of the gate insulating film 62, the semiconductor film 68, and the n⁺ semiconductor film 69 located in the display region 56 to have a thickness of about 200 nm, and then, patterning is performed using photolithography to form source electrodes and drain electrodes. At the same time, a part of the Ti film located in the seal region 57′ is patterned using the same patterning mask to form upper eave portions 91 each having a circular column shape on the upper structures 90.

Subsequently, an interlevel insulating film 63 and a protective film 64 are formed using the SiNx layer and the like, and etching is performed to form contact holes in the interlevel insulating film 63 and the protective film 64 so that each of the contact holes extends from a surface of the protective film 64 to an associated one of the drain electrodes. At the same time, etching is performed to remaining parts of the semiconductor film 68 and the gate insulating film 62 in the seal region 57′ using the same mask. In this case, an etching speed of etching of the gate insulating film 62 (SiN) is higher than an etching speed of etching of the semiconductor film 68 (a-Si), and thus, parts of the gate insulating film 62 corresponding to the plurality of circular holes formed in the semiconductor film 68 are etched faster. By further performing etching, a large part of the gate insulating film 62 is etched, and the gate insulating film 62 becomes narrow. Thus, structures 65 are formed, and an eave portion 66 is made of the semiconductor film 68 on the structures 65 so that the eave portion 66 protrudes in the direction along the surface of the glass substrate 60 to provide voids 67 under the eave portion 66. During this step, a plurality of notches 67′ are formed so that each of the notches 67′ has a circular column shape whose side portion is an associated one of the voids 67.

Next, pixel electrodes are formed on the protective film 64 so that each of the pixel electrodes is electrically coupled to an associated one of the drain electrodes through an associated one of the contact holes, and subsequently, an orientation film is formed, thus forming a thin film transistor substrate 52.

Next, similar to the first embodiment, a color filter substrate is formed, and subsequently, a sealant 57 is applied to one of the thin film transistor substrate 52 and the color filter substrate at a part thereof located closer to an associated one of the orientation films and in a seal region 57′ so as to have a substantially frame shape. Thus, the sealant 57 is located over the eave portions 66 and the upper eave portions 91 to adhere to the eave portion 66 and the upper eave portions 91, and is filled in the voids 67 and 92 formed in the gate insulating film 62 and the n⁺ semiconductor film 69 to adhere to the structures 65 and the upper structures 90.

Next, a polarizing plane is bonded to each of surfaces of the thin film transistor substrate 52 and the color filter substrate each of which is located at an opposite side to a liquid crystal layer 61 to form a liquid crystal display panel. Then, a back light is provided to the liquid crystal display panel to complete a liquid crystal display device 50.

Note that in this embodiment, a liquid crystal display device (LCD) has been described as a display device, but the present invention is not limited thereto. A display device according to the present invention may be, for example, an organic electro luminescence (organic EL) display, an inorganic electro luminescence (inorganic EL) display, an electrophoretic display, a plasma display (PD), a plasma addressed liquid crystal display (PALC), a field emission display (FED), a surface-conduction electron-emitter display (SED), and the like.

(Operational Advantages)

Next, operational advantages of embodiments of the present invention will be described.

In the liquid crystal display devices 10, 30, and 50, the plurality of structures 25, 45, and 65 are formed in the seal region 17′, 37′, and 57′ of the thin film transistor substrates 12, 32, and 52 so as to be arranged in the direction in which the seal regions 17′, 37′, and 57′ extend, and the eave portions 26, the eave portion 46, and the eave portion 66 are formed on the plurality of structures 25, 45, and 65 to protrude in the direction along the surfaces of the glass substrates 20, 40, and 60 and provide the voids 27, 47, and 67 thereunder. The sealants 17, 37, and 57 are provided on the eave portions 26, the eave portion 46, and the eave portion 66 to adhere to the eave portions 26, the eave portion 46, and the eave portion 66, and is filled in the voids 27, 47, and 67 to adhere to the structures 25, 45, and 65.

In such configurations, an adhered area of each of the sealants 17, 37, and 57 is increased because the structures 25, 45, and 65 to which the sealants 17, 37, and 57 respectively adhere, and the eave portions 26, the eave portion 46, and the eave portion 66 provided on the structures 25, 45, and 65 are formed respectively in the seal region 17′, 37′, and 57′, and thus, each of the thin film transistor substrates 12, 32, and 52 can be bonded to a color filter substrate in a good state. Also, the eave portions 26, the eave portion 46, and the eave portion 66 which are provided on the plurality of the structures 25, 45, 65 to protrude in the direction along the surface of the glass substrate 20, 40, and 60 and provide the voids 27, 47, and 67 thereunder serve as catching portions to catch the sealants 17, 37, and 57, respectively, and thus, the adhesive strength between the substrates can be further improved. Accordingly, the cell thickness between the substrates can be reliably controlled. Furthermore, the plurality of structures 25, 45, and 65 are formed to be arranged in the direction in which the seal regions 17′, 37′, and 57′ extend, and thus, moisture and a foreign matter can be preferably prevented from entering the display regions 16, 36, and 56 from the outside, so that the liquid crystal display devices 10, 30, and 50 with good display quality can be achieved.

In the liquid crystal display device 10, each of the structures 25 is formed into a raised shape.

In such a configuration, the adhered area with the sealant 17 can be increased by providing more structures 25, so that the thin film transistor substrate 12 and the color filter substrate 13 can be well bonded together.

Furthermore, in the liquid crystal display devices 10, 30, and 50, the structures 25, 45, and 65 are made of the same gate insulating films as the gate insulating films 22, 42, and 62 provided in the display regions 16, 36, and 56 on the insulating base materials, and the eave portions 26, the eave portion 46, and the eave portion 66 are made of the same semiconductor films as the semiconductor films 29, 48, and 68 on the gate insulating films 22, 42, and 62 provided in the display regions 16, 36, and 56.

In such configurations, the structures 25, 45, and 65, and the eave portions 26, the eave portion 46, and the eave portion 66 can be formed simultaneously with forming corresponding components of the liquid crystal display devices 10, 30, and 50 forming of the display regions 16, 36, and 56, using the same method. Thus, the structures 25, 45, and 65, and the eave portions 26, the eave portion 46, and the eave portion 66 can be formed simultaneously with corresponding components in a known production line without requiring additional steps. Therefore, the liquid crystal display devices 10, 30, and 50 can be fabricated with improved fabrication efficiency and reduced fabrication cost.

In the liquid crystal display device 50, the upper structures 90 each having a raised shape are formed on the eave portion 66, and the upper eave portions 91 are further formed on the upper structures 90 to protrude in the direction along the surface of the glass substrate 60 and provide the voids 92 under the upper eave portions 91.

In such a configuration, the upper structures 90 to which the sealant 57 adheres is provided in the seal region 57′, and the upper eave portions 91 are further formed on the upper structures 90. Thus, the adhered area of the sealant 57 is further increased, so that the thin film transistor substrate 52 and the color filter substrate can be bonded together in a good state. Also, the upper eave portions 91 provided on the upper structures 90 to protrude in the direction along the surface of the glass substrate 60 and provide the voids 92 under the upper eave portions 91 serve as catching portions to catch the sealant 57, and thus, the adhesive strength between the substrates can be further improved.

Furthermore, in the liquid crystal display device 50, the upper structures 90 are made of the same n⁺ semiconductor film 69 as the n⁺ semiconductor film 69 provided in the display region 56, and the upper eave portions 91 are made of the same metal thin film as a metal film of which the source electrodes and the drain electrodes are made.

In such a configuration, the upper structures 90 and the upper eave portions 91 can be formed simultaneously with corresponding components of the liquid crystal display device 50 forming the display region 56, using the same method. Thus, the upper structures 90 and the upper eave portions 91 can be formed simultaneously with corresponding components in a known production line without requiring additional steps. Therefore, the liquid crystal display device 50 can be fabricated with improved fabrication efficiency and reduced fabrication cost.

Furthermore, in the liquid crystal display devices 10, 30, and 50, the structures 25, 45, and 65 are formed to be arranged along the entire circumferences of the seal regions 17′, 37′, and 57′ surrounding the liquid crystal layers 21, 41, and 61.

In such configurations, since the structures 25, 45, and 65 are formed to be arranged along the entire circumferences of the seal regions 17′, 37′, and 57′ surrounding the liquid crystal layers 21, 41, and 61, each of the thin film transistor substrates 12, 32, and 52 can be bonded to an color filter substrate in a good state along the entire circumferences of the seal region 17′, 37′, and 57′.

### INDUSTRIAL APPLICABILITY

As described above, the present invention is useful for a display device.

1. A display device, comprising:
first and second substrates arranged to face each other, each including an insulating base material;
a display medium layer provided between the first and second substrates; and
a sealant provided in a seal region surrounding the display medium layer for bonding the first and second substrates,
wherein
in a part of the first substrate located in the seal region,
a plurality of structures are formed on the insulating base material to be arranged in a direction in which the seal region extends,
at least one eave portion is formed on the plurality of structures to protrude in a direction along a surface of the insulating base material and provide voids under the at least one eave portion, and
the sealant is provided over the at least one eave portion to adhere to the at least one eave portion and is filled in the voids to adhere to the structures.

2. The display device of claim 1, wherein
each of the structures is formed into a raised shape.

3. The display device of claim 1, wherein
the structures are formed on the insulating base material and are made of the same insulating layer as an insulating layer provided in a display region.

4. The display device of claim 1, wherein
each of the voids is a side portion of an associated one of notches formed in the insulating layer.

5. The display device of claim 1, wherein
the at least one eave portion is made of the same semiconductor film as a semiconductor film provided on a part of the insulating layer located in a display region.

6. The display device of claim 1, wherein
upper structures each having a raised shape are formed on the at least one eave portion, and upper eave portions are formed on the upper structures to protrude in a direction along the surface of the insulating base material and provide voids under the upper eave portions.

7. The display device of claim 6, wherein
the upper structures are made of the same semiconductor film as a semiconductor film provided in a display region.

8. The display device of claim 6, wherein
the upper eave portions are made of the same metal thin film as a metal thin film provided in a display region.

9. The display device of claim 1, wherein
the structures are formed to be arranged along an entire circumference of the seal region surrounding the display medium layer.
